(19) United States
(12) Patent Application Publication
(10) Pub. No.: US 2020/0290135 A1
(43) Pub. Date: Sep. 17, 2020

(54) ROTARY CUTTING TOOL FOR CHIP CONTROL

(71) Applicant: SECO TOOLS AB, Fagersta (SE)

(72) Inventor: Dennis Lee NOLAND, Brockway, PA (US)

(21) Appl. No.: 16/651,664

(22) PCT Filed: Aug. 28, 2018
(86) PCT No.: PCT/EP2018/073075

§ 371 Date: Mar. 27, 2020

Related U.S. Application Data
(60) Provisional application No. 62/565,181, filed on Sep. 29, 2017.

(51) Int. Cl. B23C 5/10

(52) U.S. Cl. CPC B23C 5/109; B23C 5/1009; B23C 2210/54; B23C 2210/0435; B23C 2210/40; B23C 2210/0492; B23C 2210/088

(57) ABSTRACT

The rotary cutting tool of the invention has helicoidal peripheral cutting edges with a wavy profile.

### FIELD OF THE DISCLOSURE

The present disclosure relates to a rotary cutting tool, and more particularly to a rotary cutting tool for machining of a workpiece by chip removing, such as a fluted end mill, having a plurality of radial cutting edges with a cutting edge pattern. The cutting edge pattern relates to a periodic pattern of teeth and to the shape and geometric relationship of the radial cutting edge forming the tooth. Additionally, one or more of the cutting edge pattern, the shape of the teeth, and the orientation of the rake face surface of the flute are designed to improve chip formation and/or cutting dynamics in regards to cutting forces and/or thermal management.

### BACKGROUND

In the discussion that follows, reference is made to certain structures and/or methods. However, the following references should not be construed as an admission that these structures and/or methods constitute prior art. Applicant expressly reserves the right to demonstrate that such structures and/or methods do not qualify as prior art against the present invention.

Heat generation during the cutting process produces a breakdown of the tool substrate material due to thermal transfer. Additionally, related art cutting processes can produce tool chips that are highly curved or spiral in shape and this mechanical deformation occurring during the cutting operation is a source of heat generation as well causing the application of increased cutting forces. Such heat and cutting forces influence the wear resistance of the tool, and are detrimental to a long tool life. New coating technologies have addressed some of the issues of thermal management and wear resistance by introducing metal, ceramic, and chemical substrates. However, further technical developments in controlling the chip formation process to reduce cutting forces and compressive stresses during cutting operation are desired to further improve thermal management and wear resistance, and to thereby increase tool life.

FIG. 11A is a view of a rotary cutting tool in accordance with related art. The related art tool has a radial cutting edge comprising a plurality of teeth arranged in a tooth pattern extending axially along the radial cutting edge. Each tooth has a profile that includes a leading edge, a trailing edge and a convexly curved crest edge joining the leading edge to the trailing edge. The leading edge and the trailing edge are both inclined radially inwardly to the axis of the tool at the same angle. The drawback with this tool is a chip formation process resulting in very segmented chips having a tight curl indicating inferior cutting process leading to high degree of segmentation of the chips, high thermal loads and stresses.

U.S. Pat. No. 3,798,723 discloses a tool with cutting teeth formed as a series of stepped serrations arranged in a tooth pattern. The cutting edge of a tooth comprises a straight cutting edge (a trailing edge) inclined radially inwardly to the axis of the tool at an angle of about 5-10° and connected with a shoulder edge (a leading edge) of the axially rearward tooth by a radius shaped valley having a small radius. The shoulder edge is inclined to the vertical at an angle of about 30°. The crest between the straight edge (the trailing edge) and the shoulder edge (the leading edge) of one and the same tooth is a sharp corner. One of the drawbacks with this tool is quick and excessive wear of parts of the cutting edge due to high thermal load and stress. One other drawback is that the tool has inferior cutting action. One further drawback is that, to achieve good chip control, the major part of the cutting tooth will cut chips having a width smaller than the width of the length of the cutting tooth. Accordingly, there is a large portion of each tooth will not be utilized in the cutting operation, which is not economical.

### SUMMARY

Accordingly, the present disclosure is directed to a rotary cutting tool for chip control that substantially obviates one or more of the issues due to limitations and disadvantages of related art tools and methods.

An object of the present disclosure is to provide an economically viable, improved rotary cutting tool that provides an improved cutting operation with higher metal removal rates, longer tool life, and enhanced chip evacuation as compared to the related art. Another object of the present disclosure is to provide improved chip control of a rotary cutting tool. Another object of the present disclosure is to provide a rotary cutting tool with improved chip formation and flow processes of the rotary cutting tool. At least one or some of the objectives is achieved by means of the tool having the features defined in claim 1.

Additional features and advantages will be set forth in the description that follows, and in part will be apparent from the description, or may be learned by practice of the invention. The objectives and other advantages of the disclosed rotary cutting tool will be realized and attained by the structure particularly pointed out in the written description and claims thereof as well as the appended drawings.

To achieve these and other advantages and in accordance with the purpose of the present disclosure, as embodied and broadly described, the disclosed rotary cutting tools and end mills, and more particularly fluted end mills, have a plurality of cutting edges with a cutting edge pattern that is designed to produce a surface that is perpendicular to the plane of maximum shear potential of the combined helix angle and radial rake angle of the tool. The disclosed rotary cutting tool includes “knuckles” along the cutting edge which result in straighter, less damaged chips and enhance chip disposal, and also reduce cutting forces.

A tool according to the invention comprises a tool body comprising a longitudinal center axis of rotation, the tool body being elongated and rotatable along the longitudinal center axis of rotation; a fluted cutting end portion and a shank portion that is axially opposite the fluted cutting end portion, the fluted cutting end portion comprising a periphery surface and an end surface; at least one flute including a flute surface, the flute surface projecting radially inward into the tool body and extending along a first portion of the periphery surface in an axial direction of the tool body; and a clearance surface extending circumferentially along a second portion of the periphery surface, and forming part of a wave pattern in an axially extending direction; and a radial cutting edge formed at an intersection of the flute surface and the clearance surface. The radial cutting edge has a radial cutting edge geometry comprising a plurality of teeth arranged in a tooth pattern extending axially along the radial cutting edge, wherein each tooth of the tooth pattern has a profile that includes a leading edge, a trailing edge, and a convexly curved crest edge joining the leading edge to the trailing edge, the largest radial distance of the radial cutting edge located in the convexly curved crest edge, wherein, in the tooth pattern, a leading edge of an axially rearward tooth is joined to a trailing edge of an axially forward tooth by a curved valley, the valley defining the smallest radial distance of the radial cutting edge. A projection of at least one tooth of the tooth pattern onto an imaginary plane at a midpoint of the leading edge of the at least one tooth and containing the longitudinal center axis comprises a projection of the leading edge, a projection of the tailing edge and a projection of the crest of the at least one tooth, said projection of the at least one tooth forms an imaginary triangle, the imaginary triangle having: (i) an apex vertex located at an intersection of an imaginary extension of the projection of the leading edge of the at least one tooth and an imaginary extension of the projection of the trailing edge of the at least one tooth, (ii) a leading vertex located at an intersection of the imaginary extension of the projection of the leading edge of the at least one tooth and an imaginary extension of a projection of the trailing edge of the axially forward tooth onto the imaginary plane, and (iii) a trailing vertex located at an intersection of the imaginary extension of the projection of the trailing edge of the at least one tooth and an imaginary extension of a projection of the leading edge of the axially rearward tooth onto the imaginary plane, wherein the imaginary triangle has a leading edge side between the apex vertex and the leading vertex, a trailing edge side between the apex vertex and the trailing vertex, and a base side between the leading vertex and the trailing vertex, wherein the trailing edge side is oriented at a first angle (α) relative to the base side and the leading edge side is oriented at a second angle (β) relative to the base side, and wherein the second angle (β) is greater than the first angle (α).

Thanks to the convexly curved crest edge joining the leading edge to the trailing edge, the chips are not subject to unnecessary large local deformation, the chip formation is facilitated, cutting forces and compressive stresses are reduced, the thermal management is improved, a slower wear development is achieved and tool life is improved.

According to one embodiment, the radial cutting edge is helically curved. It is observed that a helically curved radial cutting edge having a positive helix angle up to 60 degrees further improves results related to chip control and best results are achieved when helix angle is between 30 degrees and 45 degrees.

According to one embodiment, the vertices and sides of the imaginary triangle have specified angular relationships that promote efficient chip formation and contribute to reduced stress, reduced wear and improved thermal management. For example, the first angle (α) is 25 degrees to 44 degrees. Thanks to this, also a more economic tool is achieved as the entire length of the trailing edge can be used on all teeth at the same time as good chip forming and chip control are achieved. Also, better productivity can be achieved as the cutting rate, especially feed per tooth, can be increased. In other examples, the second angle (β) is 46 degrees to 65 degrees. Thanks to this, also better productivity can be achieved as the cutting rate, especially feed per tooth, can be increased. In still further examples, the first angle (α) is 25 degrees to 44 degrees and the second angle (β) is 46 degrees to 65 degrees. Thanks to this, also improved cutting dynamics in regards to cutting forces is achieved and a further increase of productivity can be achieved. In still further examples, the first angle (α) is 25 degrees to 44 degrees, the second angle (β) is 46 degrees to 65 degrees and a sum of the first angle (α) and the second angle (β) is 80 degrees to 100 degrees. For some workpiece materials, the sum of the first angle (α) and the second angle (β) should be in the lower range of this interval and for other workpiece materials the sum should be in the higher range of this interval. It is observed that the chip control is improved when the sum is within the mentioned interval. More preferably the sum of the first angle (α) and the second angle (β) is 85 degrees to 95 degrees and most preferably the sum is 88 degrees to 92 degrees which gives the best overall result in relation to enhanced chip disposal and reduced cutting forces when one tool is used for machining different workpiece materials.

According to one embodiment, associated with the flute surface there is provided a rake face surface adjacent both (a) at least a portion of the leading edge and (b) at least a portion of the trailing edge, and wherein at least a portion of the rake face surface is planar in a radial direction and curved in an axial direction. It is observed that this feature gives further improvements in relation to chip control, chip flow and thermal management.

According to one embodiment, a portion of the flute surface adjacent the radial cutting edge defines a rake face surface that, in a cross-section orthogonal to the longitudinal center axis of rotation at an axial position corresponding to the convexly curved crest edge of at least one tooth, has a planar surface geometry (or optionally has a non-planar surface geometry) that separates a concave portion of the flute surface from the radial cutting edge. It is observed that this feature gives further improvements in relation to chip control, chip flow and thermal management.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with the embodiments of the disclosed cutting tool. It is to be understood that both the foregoing general description and the following detailed description of the disclosed cutting tool are examples and explanatory, and are intended to provide further explanation of the disclosed cutting tool as claimed.

### BRIEF DESCRIPTION OF THE DRAWINGS

The accompanying drawings, which are included to provide a further understanding of the invention and are incorporated in and constitute a part of this specification, illustrate implementations of the invention and together with the description serve to explain the principles of the disclosure.

FIG. 1A is an isometric view of a rotary cutting tool in accordance with an embodiment of the disclosed cutting tool.

FIG. 1B is a vertically oriented side plan view of the rotary cutting tool of FIG. 1A.

FIG. 1C is a horizontally oriented side plan view of the rotary cutting tool of FIG. 1A.

FIG. 1D is an end plan view of the rotary cutting tool of FIG. 1A.

FIG. 2A is a side plan view of the rotary cutting tool of FIG. 1A.

FIG. 2B is a magnified view detailing a portion of the radial cutting edge geometry of the rotary cutting tool illustrated in FIG. 2A.

FIGS. 3A and 3B schematically illustrate equal (FIG. 3A) and unequal (FIG. 3B) staggering of the tooth pattern of radial cutting edges associated with different flutes.

FIGS. 4A to 4D illustrate details of the projection of the tooth form.

FIGS. 5A to 5H illustrate details of projections of the tooth form associated with teeth of alternative embodiments of the radial cutting edge geometry.

FIG. 6A is another image of the side plane view of the rotary cutting tool of FIG. 1A.

FIGS. 6B to 6E are each axial cross-sections of the tool in FIG. 6A along line B-B′, line C-C′, line D-D′, and line E-E′, respectively.

FIG. 7A is an isometric view of an intermediate form of the rotary cutting tool and illustrating some geometric features of the rotary cutting tool including the angle of the plane of maximum shear potential in relation to the helix angle and the radial rake angle of a rotary cutting tool in accordance with an embodiment of the disclosed cutting tool.

FIG. 7B is a magnified view of a portion of FIG. 6A illustrating the geometry of the rake face surface and the location of the leading edge of the tooth forming the radial cutting edge geometry.

FIG. 7C is a schematic diagram illustrating the geometric relationship of various features of the rotary cutting tool and the tooth of the radial cutting edge.

FIG. 7D is a schematic representation illustrating relationships relevant to determining a desired roughing form profile.

FIG. 8 schematically illustrates an embodiment with a continually changing helical curvature of the helically curved radial cutting edge with axial position relative to the longitudinal center axis.

FIG. 9 shows graphs of select characteristics during a simulation of chip formation flow of a rotary cutting tool in accordance with an embodiment of the disclosed cutting tool.

FIG. 10 shows graphs of select characteristics during a simulation of chip formation flow of a related art rotary cutting tool.

FIG. 11A is a view of a rotary cutting tool and chips in accordance with a related art.

FIG. 11B is a view of a rotary cutting tool and chips in accordance with an embodiment of the disclosed cutting tool.

Throughout the drawings and the detailed description, unless otherwise described, the same drawing reference numerals should be understood to refer to the same elements, features, and structures, unless context dictates otherwise. The relative size and depiction of these elements may be exaggerated for clarity, illustration, and convenience. Furthermore, in some instances, reference numerals have not been applied to each instance of each feature in a particular figure so as to reduce the complexity of the reference numeral labeling and also to improve the overall comprehension of the information conveyed in the figures. In such instances, the identity of non-labeled features can be readily understood from the description and the other reference numerals.

### DETAILED DESCRIPTION

In the following detailed description, reference is made to the accompanying drawings, which form a part hereof. In the drawings, the use of similar or the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here. The progression of processing steps and/or operations described is an example; however, the sequence of steps and/or operations is not limited to that set forth herein and may be changed as is known in the art, with the exception of steps and/or operations necessarily occurring in a certain order.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Based on a study of the mechanism in material cutting in conjunction with the principles of chip development technology, the disclosed cutting tool reduces heat generation and compressive stresses by making the rotary cutting tool with a cutting face profile that will control the size, shape, and flow direction of the chip generation.

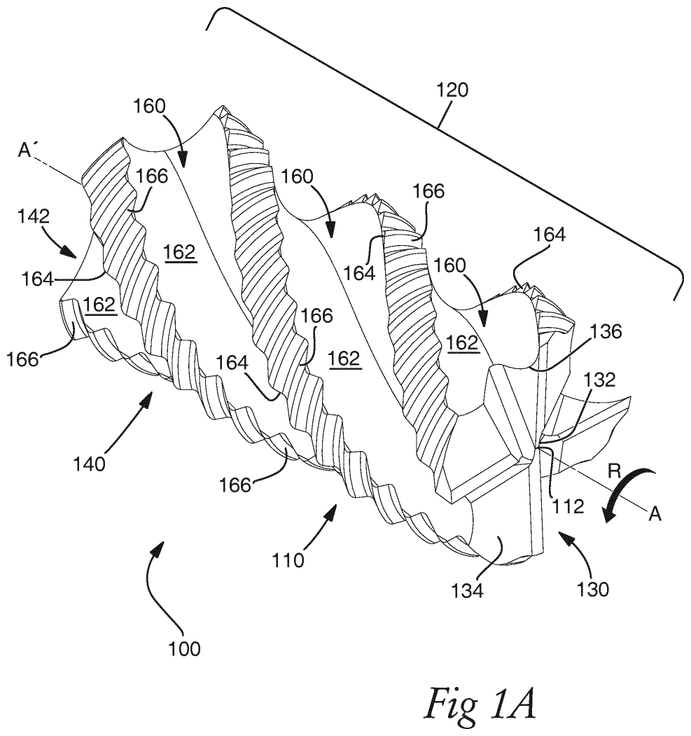

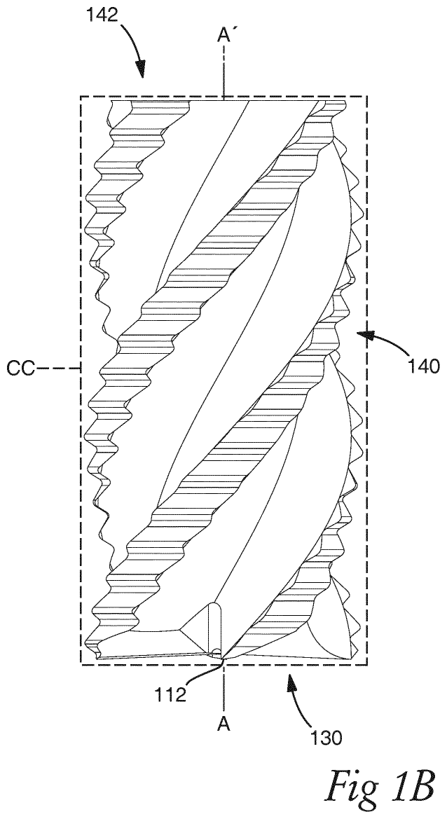

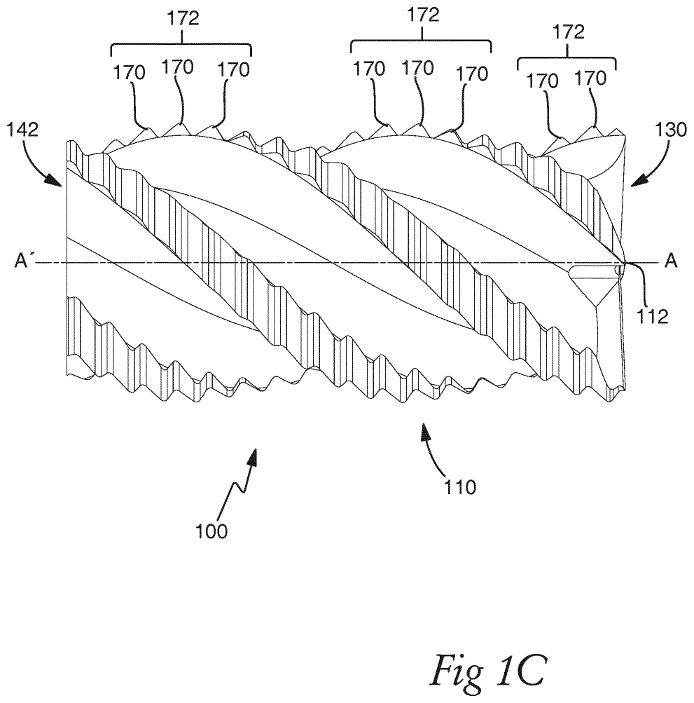

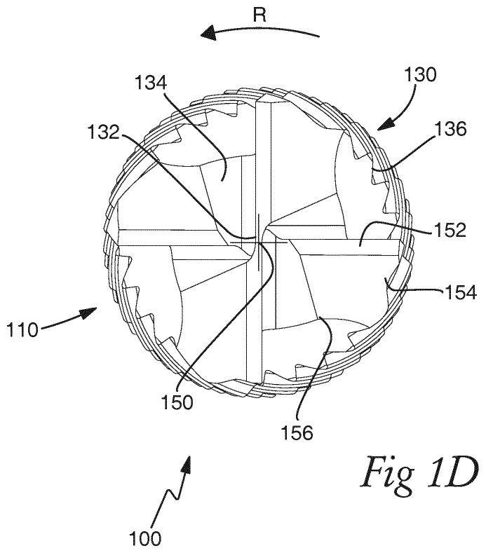

FIGS. 1A to 1D are, respectively, an isometric view, a vertically oriented side plan view, a horizontally oriented side plan view, and an end plan view of a rotary cutting tool in accordance with an embodiment of the present disclosure. The rotary cutting tool illustrated in FIGS. 1A to 1D is a roughing end mill, and this particular rotary cutting tool is used as an example embodiment here and throughout this disclosure. However, the features, improvements, methods, processes and other technical details disclosed herein, while illustrated for example purposes only on a roughing end mill, are also applicable to other categories and types of rotary cutting tools, such as other types of end mills, face mills, side mills, and drilling tools having a point geometry.

FIGS. 1A to 1D show a rotary cutting tool 100 with a radial cutting edge 164 that has a radial cutting edge geometry comprising a plurality of teeth arranged in a tooth pattern extending axially along the radial cutting edge as described further herein. The rotary cutting tool 100 includes a tool body 110 including a longitudinal center axis of rotation A-A′, which passes through the longitudinal center 112 of the tool body 110. The tool body 110 may be elongated, can optionally have one of a cylindrical shape, a conical shape, or a contoured shape, and is rotatable along the longitudinal axis of rotation A-A′ passing through the center 112 of the tool body 110. The rotary cutting tool 100 further includes a fluted cutting end portion 120 and a shank portion (not shown) axially rearward of the fluted cutting end portion 120. The fluted cutting end portion 120 includes an end surface 130 and a peripheral surface 140. The peripheral surface 140 extends axially rearward from the end surface 130 along the direction of the longitudinal axis of rotation A-A′ to a location along the tool body 110 where the fluted cutting end portion 120 transforms into the shank portion.

The end surface 130 of the fluted cutting end portion 120 of the tool 100 includes a nose 132, which may be coincident with or offset from the longitudinal center 112 of the tool body 110, and a front surface 134 extending from the nose 132 to a radial periphery 136, the radial periphery 136 being formed by the intersection of the front surface 134 with the surfaces of the axially extending peripheral surface 140 (and any features thereof) of the tool body 110 (see also FIG. 1D). As such, the radial periphery 136 of the end surface 130 is irregularly shaped due to it following the contour of the radial limit of the front surface 134, such as that associated with (where applicable) the chisel edge 150, the lip 152, the land 154, and the web 156 of the front surface 134 (examples of which are illustrated in FIG. 1D, albeit reference numerals are only applied to one quadrant of the front surface 134).

The rearward end 142 of the fluted cutting end portion 120 is illustrated (for example, in FIGS. 1B and 1C) as planar, but in application may be attached to or integral with a longitudinally extending shank portion (not shown) extending along the longitudinal axis of rotation A-A′ rearward of the fluted cutting end portion 120. At an axially opposite end of the tool 100 from the end surface 130, the shank portion may optionally have a means for attaching the rotary cutting tool 100 (for example, via a chuck or a clamping device) to an apparatus for machining, such as a machine tool or a computer numerical control (CNC) machine.

The rotary cutting tool 100 may further include a plurality of flutes 160. Each of the plurality of flutes 160 extends from the radial periphery 136 of the end surface 130 helically rearward on the peripheral surface 140 in an axial direction of the tool body 110 along at least a portion of the axial length of the fluted cutting end portion 120. Alternatively, one or more or all of the flutes of the plurality of flutes 160 extends rearward along a majority portion of the axial length of the fluted cutting end portion 120. Still further alternatively, one or more or all of the flutes of the plurality of flutes 160 extends rearward along the entire axial length of the fluted cutting end portion 120. Each of the plurality of flutes 160 includes a flute surface 162 that projects radially inward into the tool body 110. The flutes of the plurality of flutes 160 are located symmetrically or asymmetrically with each other around the longitudinal axis of rotation A-A′. The example embodiment shown in FIGS. 1A to 1D includes four flutes, but the rotary cutting tool 100 may alternatively include two, three, four, five or six flutes or greater. Further, the example embodiment shown in FIGS. 1A to 1D is a right-handed tool (meaning, when viewed from the end surface 130 along the longitudinal axis of rotation A-A′, the tool 100 is rotated counter-clockwise in order to cut (indicated by direction R in FIGS. 1A and 1D)), but other embodiments can be a left-handed tool.

The flutes 160 can be spaced apart from each other, each of the plurality of flutes 160 including an integral adjacent radial cutting edge 164 along a side of the flute 160 for engaging and cutting a workpiece. Each radial cutting edge 164 is typically helically curved and includes a radial cutting edge geometry such that a radially outermost point of each radial cutting edge 164 is located on the surface of an imaginary circumscribing cylinder (see, for example, imaginary circumscribing cylinder CC illustrated in vertical side plan view in FIG. 1B) defined by the rotation of the radial cutting edges 164 about the longitudinal axis of rotation A-A′ of the tool body 110.

As seen in FIGS. 1A to 1D, each flute 160 is spaced apart from an adjacent flute 160 by an intervening radial cutting edge 164 and its associated circumferentially extending clearance surface 166. The circumferentially extending clearance surface 166 forms part of a helical wave pattern in an axially extending direction, meaning the clearance surfaces 166 are spatially periodic along a helix.

A radial cutting edge 164 is formed at an intersection of each flute surface 162 and the associated clearance surface 166. The radial cutting edge 164 has a radial cutting edge geometry comprising a plurality of teeth 170 arranged in a tooth pattern 172 extending axially along the radial cutting edge 164.

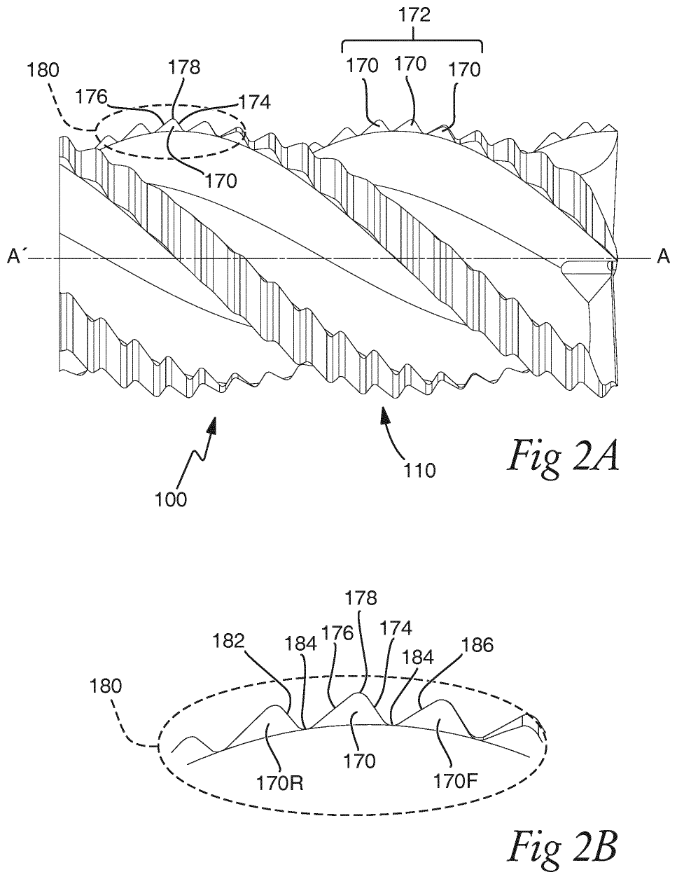

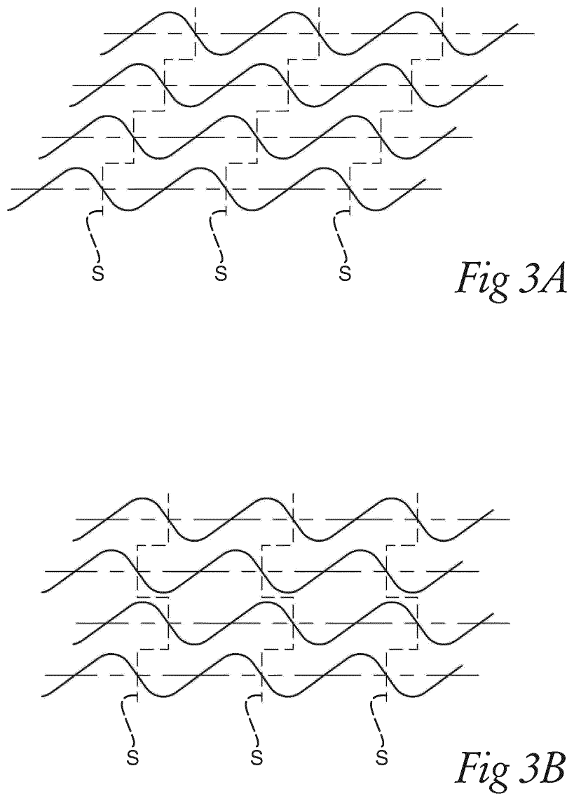

As seen in FIG. 2A, each tooth 170 in the tooth pattern 172 has a profile that includes a leading edge 174, a trailing edge 176, and a convexly curved crest edge 178 joining the leading edge 174 to the trailing edge 176. In optional embodiments, the surface joining the convexly curved crest edge 178 to the trailing edge 176 and the leading edge 174 forms a tangential connection, meaning the connecting surface is continuously curving and without a planar region. In other optional embodiments, a planar region may be included in the convexly curved crest edge 178 as long as any such planar region is a minor portion of the entire length of the convexly curved crest edge 178. The leading edge 174 faces the forward axial direction of the tool 100 and the trailing edge 176 faces the rearward axial direction of the tool 100, i.e., the clamping or mounting end of the tool. A magnified view of one tooth 170 from FIG. 2A designated by dashed circle 180 is shown in FIG. 2B. In both FIG. 2A and FIG. 2B, only the leading edge 174, the trailing edge 176, and the convexly curved crest edge 178 of one tooth 170 is labeled with these reference numerals, but the same identification readily applies to the other teeth in the tooth pattern 172 as well as the teeth 170 in the tooth patterns 172 of other radial cutting edges 164.

In the tooth pattern, a leading edge of an axially rearward tooth is joined to a trailing edge of an axially forward tooth by a curved valley. For illustration, reference is made to FIG. 2B. In the tooth pattern 172, a leading edge 182 of an axially rearward tooth 170R is joined to the trailing edge 176 of an axially forward tooth 170 by a curved valley 184. This arrangement is repeated as seen in FIG. 2B wherein the leading edge 174 of tooth 170 (the axially rearward tooth in this instance) is joined to the trailing edge 186 of an axially forward tooth 170F by a curved valley 184.

In example embodiments of the tooth pattern 172, the largest radial distance of the radial cutting edge 164 is located in the convexly curved crest edge 178 of the profile and the valley 184 defines the smallest radial distance of the radial cutting edge 164. Additionally, similar locations on the convexly curved crest edge 178 on different teeth 170 in the tooth pattern 172 for a given radial cutting edge 164 are located at substantially (i.e., within manufacturing tolerances) the same distance from the longitudinal axis of rotation A-A′ of the tool body 110.

Each of the convexly curved crest edge 178 and the curved valley 184 have a curvature, the size of which is defined by a respective radius. For example, the size of the curvature of the crest edge is defined by a crest edge radius and the size of the curvature of the valley is defined by a valley radius. The crest edge radius and the valley radius are each sized to reduce the stress riser condition at the crest point and valley intersection, respectively. Softer materials allow a smaller radius and harder materials require a larger radius. In example embodiments, the size of the crest radius and the size of the valley radius are each in a range of from 5% to 25% of the length of the leading edge side of imaginary triangle 210 (further disclosed and described below).

In reference to, for example, the vertical side plan view illustrated in FIG. 1B and the above description of the tooth pattern, when the tool is rotated about the longitudinal center axis of rotation, the profile of the teeth in the tooth pattern create a profile of an imaginary surface. This imaginary surface is based, at least in part, on the leading edge 174, the trailing edge 176, and the convexly curved crest edge 178 as the tool is rotated. As such, the imaginary surface has a geometry that corresponds to that of the profile of the teeth in the tooth pattern. Accordingly, portions of the imaginary surface will be planar or non-planar in correspondence to the planarity or non-planarity character of the edges of the tooth.

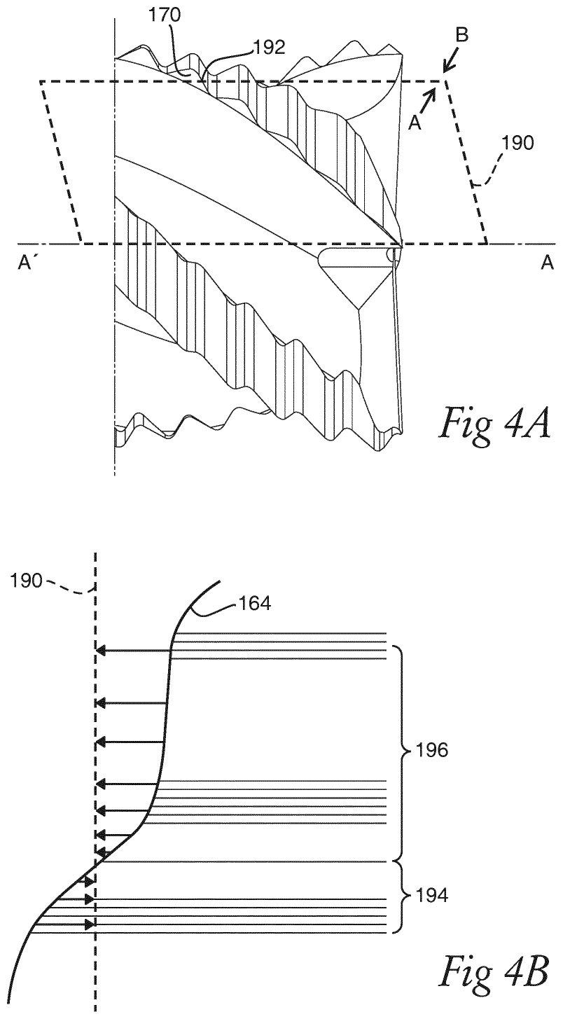

As seen for example in FIG. 1C, the tooth pattern 172 is determined in relation to the teeth 170 on any one radial cutting edge 164. In some embodiments, the tooth pattern 172 will be the same between more than one radial cutting edge 164 in one or more of geometry, axial position relative to the longitudinal axis of rotation A-A′, and periodicity, and is optionally the same between more than one radial cutting edges 164 in more than one, alternatively all, of geometry, axial position, and periodicity. In still other embodiments, the tooth pattern 172 will be the same in one or more of geometry, axial position, and periodicity between all radial cutting edges 164 and is optionally the same in more than one, alternatively all, of geometry, axial position, and periodicity between all radial cutting edges 164. For example, the plurality of teeth arranged in the tooth pattern of the radial cutting edge of a first flute can be geometrically the same as the teeth arranged in the tooth pattern of the radial cutting edge 164 of a second flute. Optionally, the tooth patterns may be different, for example in geometry, or the tooth pattern on two radial cutting edges may be the same, for example in geometry, but these two tooth patterns may differ, for example in geometry, from a tooth pattern on a third radial cutting edge, which allows for different tooth styles/shapes at different radial cutting edges. In another example, the tooth patterns can be the same, but the tooth pattern of the radial cutting edge of a first flute is axially staggered from the tooth pattern of the radial cutting edge of a second flute. In a further example, the tooth patterns can be the same, but the tooth pattern of the radial cutting edge of a first flute is radially staggered from the tooth pattern of the radial cutting edge of a second flute. FIGS. 3A and 3B schematically illustrate examples of staggering, respectively, where dashed line S connects corresponding positions on the tooth patter of the radial cutting edge of different flutes. Furthermore, although illustrated in various figures as including three teeth, the tooth pattern 172 is not limited to three teeth and more than three teeth, including up to all the teeth on one cutting edge, is expressly contemplated.

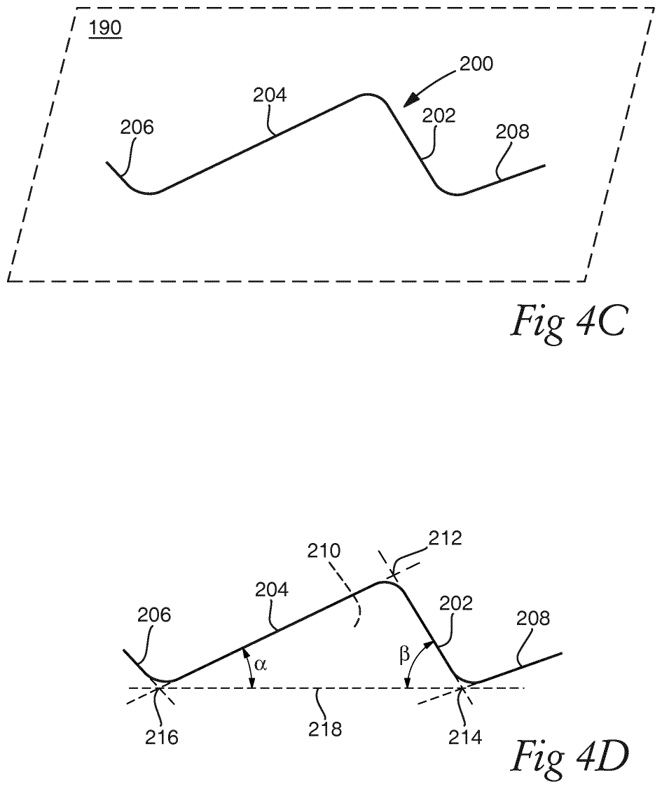

The leading edge 174 and the trailing edge 176 of each tooth 170 in the tooth pattern 172 form a geometry of the tooth 170 whereby the leading edge 174 is at a larger angle relative to the longitudinal axis of rotation A-A′ of the tool body 110 than the trailing edge 176. This specific angular relationship of each tooth 170 is embodied in the geometry of an imaginary triangle representing the projection of the tooth 170 onto an imaginary plane 190 containing the longitudinal axis of rotation A-A′ of the tool body 110 and containing the midpoint 192 of the leading edge 174 of the specific tooth 170 (the midpoint being equidistant along the length of radial cutting edge 164 between (a) the location of the largest radial distance of the radial cutting edge 164 located in the convexly curved crest edge 178 and (b) the location of the smallest radial distance of the radial cutting edge 164 located in the valley 184 between the leading edge 174 and the trailing edge 186 of the axially forward tooth 170F). This imaginary plane 190 for one tooth 170 having midpoint 192 is illustrated in FIG. 4A.

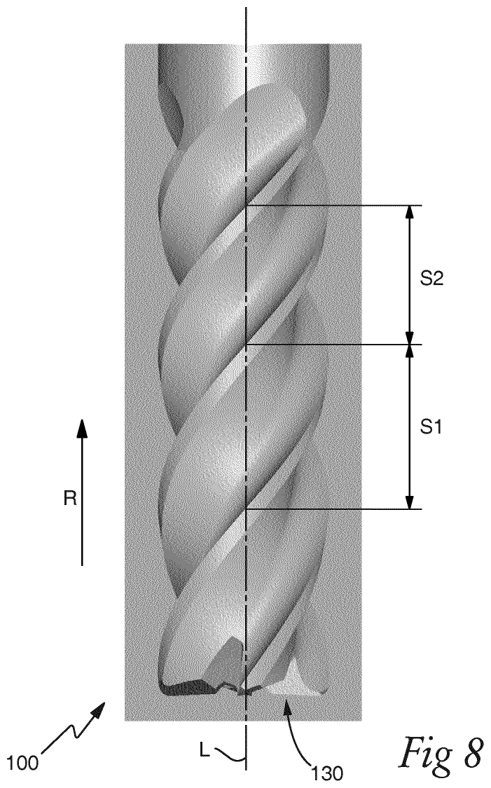

The radial cutting edge 164 is on a helix (for example, on a helix having a helix angle in a range of 0 degrees to 60 degrees, alternatively a range of 35 degrees to 50 degrees). In some embodiments the helical curvature of the helically curved radial cutting edge is constant. In other embodiments, the helical curvature of the helically curved radial cutting edge continually changes with axial position relative to the longitudinal center axis (see, for example, the embodiment shown in FIG. 8). In FIG. 8, the axial spacing S between successive radial cutting edges 164 intersecting an imaginary line L parallel to the longitudinal center axis of rotation A-A′ decreases as one moves rearwardly (in direction R) from the end surface 130 along the direction of the longitudinal axis of rotation A-A′ toward a location along the tool body 110 where the fluted cutting end portion 120 transforms into the shank portion. FIG. 8 illustrates an example where the dimension of axial spacing S1 is larger than the dimension of axial spacing S2.

In both embodiments, because the radial cutting edge 164 is on a helix, a first portion 194 of the radial cutting edge 164 of tooth 170 that is axially forward of the midpoint 192 is on a first side (indicated by A in FIG. 4A) of the imaginary plane 190 and a second portion 196 of the radial cutting edge 164 of tooth 170 that is axially rearward of the midpoint 192 is on a second side (indicated by B in FIG. 4A) of the imaginary plane 190. Therefore, to form the imaginary triangle, the first portion 194 of the radial cutting edge 164 of tooth 170 and the second portion 196 of the radial cutting edge 164 of tooth 170 are projected onto the imaginary plane 190 by taking each location on the first portion 194 and second portion 196 and translating it at a 90 degree angle to the imaginary plane 190 onto the surface of the imaginary plane 190 (represented by dashed arrowed lines in FIG. 4B). FIG. 4B schematically illustrates this process for one tooth 170. After completing the projection process described above, the projected profile 200 of one tooth is represented on the imaginary plane 190, as shown in FIG. 4C and includes a projection 202 of the leading edge of the tooth and a projection 204 of the trailing edge of the tooth. Portions of the projection 206 of the trailing edge of the axially forward tooth and the projection 208 of the leading edge of the axially rearward tooth are also shown.

An imaginary triangle 210 associated with the projected profile 200 can be formed as follows and as illustrated in FIG. 4D. The imaginary triangle 210 has three apexes—an apex vertex 212, a leading vertex 214, and a trailing vertex 216. The apex vertex 212 is located at an intersection of an imaginary extension of the projection 202 of the leading edge of the tooth and an imaginary extension of a projection 204 of the trailing edge of the tooth. The leading vertex 214 is located at an intersection of the imaginary extension of the projection 202 of the leading edge of the tooth and an imaginary extension of a projection 206 of the trailing edge of the axially forward tooth. The trailing vertex 216 is located at an intersection of the imaginary extension of the projection 204 of the trailing edge of the tooth and an imaginary extension of the projection 208 of the leading edge of the axially rearward tooth. Connecting each of the apex vertex 212, the leading vertex 214, and the trailing vertex 216 with straight lines forms the imaginary triangle 210, which has a leading edge side between the apex vertex 212 and the leading vertex 214, a trailing edge side between the apex vertex 212 and the trailing vertex 216, and a base side 218 between the leading vertex 214 and the trailing vertex 216.

The vertices and sides of the imaginary triangle 210 have specified angular relationships that promote efficient chip formation and contribute to reduced stress, reduced wear and improved thermal management. These relationships include orienting the trailing edge side at a first angle (α) relative to the base side 218 and orienting the leading edge side at a second angle (β) relative to the base side 218 such that the second angle (β) is greater than the first angle (α). In specific embodiments, the first angle (α) is 25 degrees to 44 degrees. In other specific embodiments, the second angle (β) is 46 degrees to 65 degrees. In still further embodiments, the first angle (α) is 25 degrees to 44 degrees and the second angle (β) is 46 degrees to 65 degrees. In still further embodiments, the first angle (α) is 25 degrees to 44 degrees, the second angle (β) is 46 degrees to 65 degrees, and a sum of the first angle (α) and the second angle (β) is 80 degrees to 100 degrees.

The above-described configuration and angular relationships are parameters influencing the chip forming dynamics when the tool 100 cuts a workpiece and provide technical effects of enhanced chip disposal at least in part due to reduced segmentation of the chip and minimization of the curl of the chip, both of which are physical indicators of reduced energy needed to form the chip.

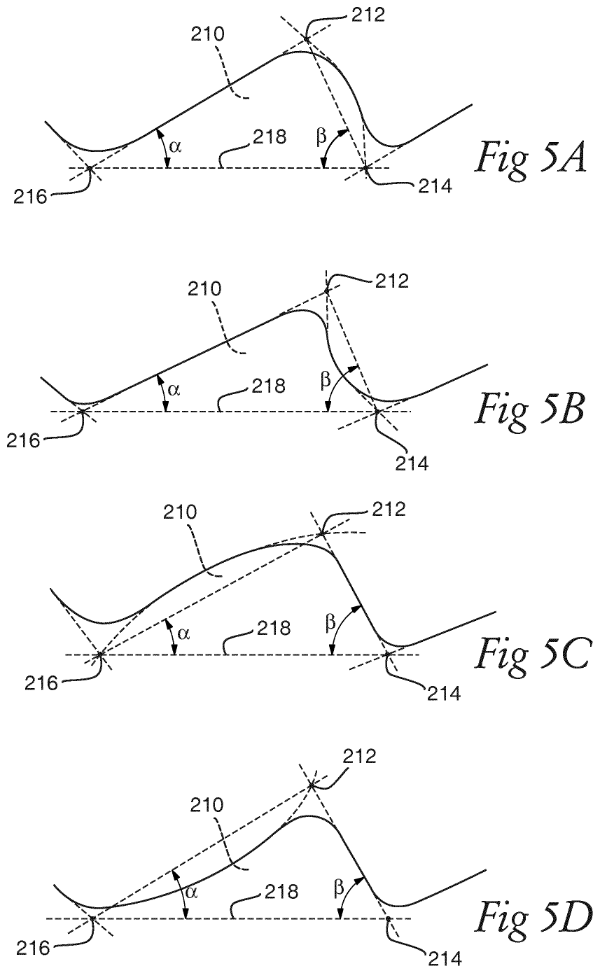

In a first embodiment of a tooth profile, the leading edge 174 and the trailing edge 176 are both planar. One way to determine planarity of these surfaces is that along the length of the leading edge 174 or the trailing edge 176, the distance from the longitudinal center axis of rotation to the cutting edge varies linearly. In such an embodiment, the extensions used in the formation of the imaginary triangle are straight linear extensions of the projections 202, 204 of the leading edge and trailing edge of the tooth. In alternative embodiments, at least one of the leading edge 174 and the trailing edge 176 is non-planar and, as a result, the associated projection is also non-planar, i.e., concave or convex. In the instance where the associated projection is non-planar, the extension of the projection is obtained based on a straight linear extension of the tangent of the projection 202 of the leading edge of the tooth and/or the projection 204 of the trailing edge of the tooth at the point where the respective projections end, i.e., at the inflection point where the non-planar character of the projection changes from concave to convex (for a concave projection) or from convex to concave (for a convex projection). FIGS. 5A to 5H illustrate forming the imaginary triangle 210 for these alternative embodiments and illustrates examples of the projected profile 200 of one tooth of the tooth pattern in which at least one of the projection 202 of the leading edge and the projection 204 of the trailing edge is non-planar according to Table 1.

TABLE 1

| FIGURE | Character of Leading Edge | Character of Trailing Edge |
|---|---|---|
| 5A | convex | planar |
| 5B | concave | planar |
| 5C | planar | convex |
| 5D | planar | concave |
| 5E | convex | convex |
| 5F | concave | concave |
| 5G | concave | convex |
| 5H | convex | concave |

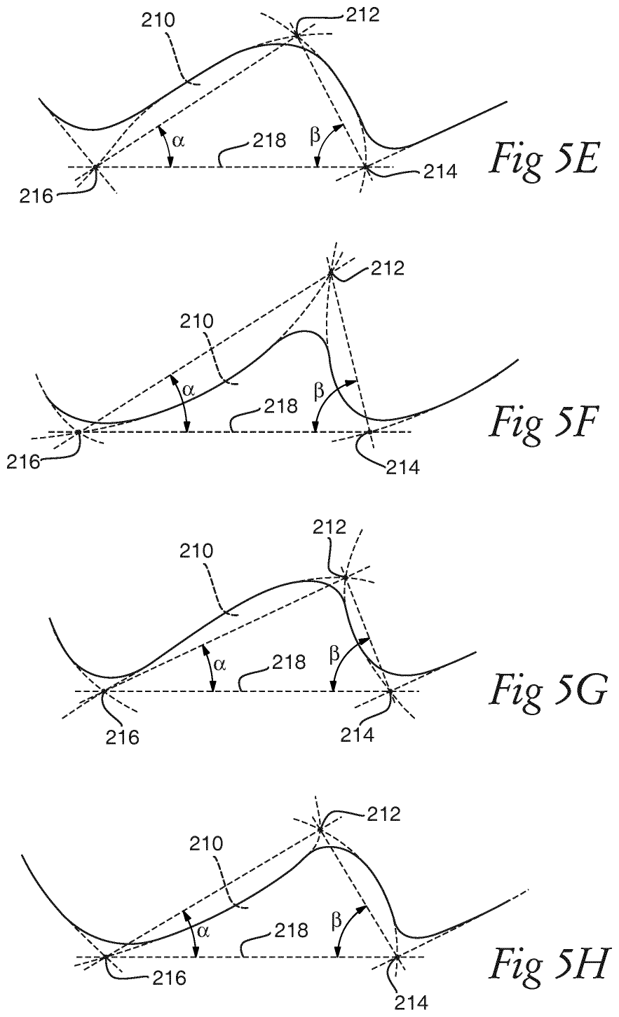

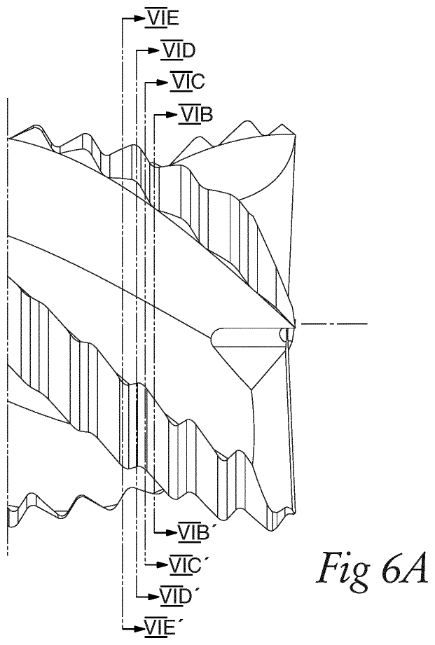

FIG. 6A is another image of the side plane view of the rotary cutting tool of FIG. 1A. FIGS. 6B to 6E are each cross-sections of the tool in FIG. 6A along line B-B′, line C-C′, line D-D′, and line E-E′, respectively. Note, the cross-sections are orthogonal to the longitudinal center axis of rotation. In FIGS. 6B to 6E, features of the peripheral surface 140 of the fluted cutting end portion 120 are illustrated for the different cross-section locations: the cross-section along line B-B′ (FIG. 6B) is at the location of the smallest radial distance of the radial cutting edge 164, the cross-section along line C-C′ (FIG. 6C) is at the location of the mid-point 192 of the leading edge 174 of the tooth 170; the cross-section along line D-D′ (FIG. 6D) is at the location of the largest radial distance of the radial cutting edge 164 located in the convexly curved crest edge 178; and the cross-section along line E-E′ (FIG. 6E) is at the location of the mid-point of the of the trailing edge 176 of the tooth 170. In each of FIGS. 6B to 6E, multiple teeth are illustrated, but the tooth 170 used as the reference point of the cross-section is the upper right tooth labeled with “T”. Additionally, in FIGS. 6B to 6E, imaginary circle 250 is associated with the cutting radius for the largest radial distance of the radial cutting edge 164 and the inner dashed imaginary arcs 252, 254, 256 are associated with the cutting radius for the radial distance of the tooth presented in that corresponding cross-section.

As seen variously in FIGS. 6A to 6E, the flute surface 162 includes a rake face surface 300 that is adjacent the radial cutting edge 164. The extent of the flute surface 162 occupied by the rake face surface 300 can vary and this variation is another parameter influencing the chip forming dynamics when the tool 100 cuts a workpiece.

For example, as seen from FIGS. 6A, 6C, and 6E, the rake face surface 300 is adjacent both (a) at least a portion of the leading edge 174 of the tooth 170 and (b) at least a portion of the trailing edge 176 of the tooth 170. In both of these portions, the rake face surface 300 is planar in a radial direction as well as curved in an axial direction (as discernible, for example, from FIGS. 1A, 2A, 6A, 6C, 6E and 7A-7B).

In another example, as seen from FIG. 6D, in a cross-section orthogonal to the longitudinal center axis of rotation at an axial position corresponding to the convexly curved crest edge 178 of at least one tooth 170, the rake face surface 300 has a planar surface geometry separating a concave portion 310 of the flute surface 160 from the radial cutting edge 164. The rake face surface 300 is planar in a radial direction as well as curved in an axial direction (as discernible, for example, from FIGS. 1A, 2A, 6A, 6C, 6E and 7A-7B).

In a further example, as seen from FIGS. 6B to 6E, the rake face surface 300 includes a first region 320 that (i) is located radially outward of an imaginary baseline formed by connecting the following points on the radial cutting edge 164 associated with an individual tooth: an apex of the axially forward valley 184 and an apex of the axially rearward valley 184, and (ii) is adjacent to at least a portion of the convexly curved crest edge 178. In this first region 320, the rake face surface 300 is planar in a radial direction as well as curved in an axial direction (as discernible, for example, from FIGS. 1A, 2A, 6A-6E and 7A-7B). Optionally, the rake face surface can include a second region 330 located radially inward of the imaginary baseline. This second region 330 can also be planar in the radial direction and curved in the axial direction (as discernible, for example, from FIGS. 1A, 2A, 6A and 7A-7B).

In each of the above instances, the plane of the rake face surface 300 is not coincident with a radius of the tool. Additionally, the planar rake face surface 300 can be oriented with a positive rake angle or a negative rake angle.

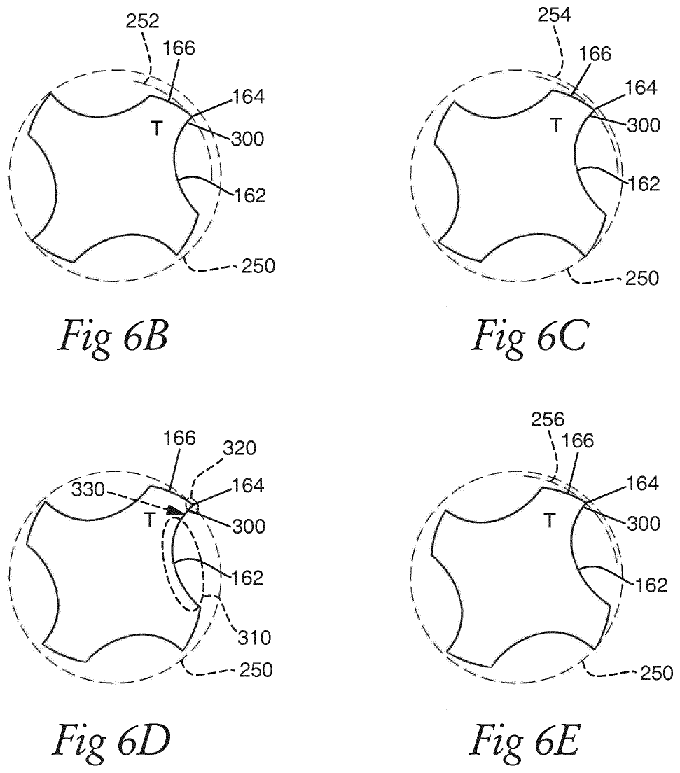

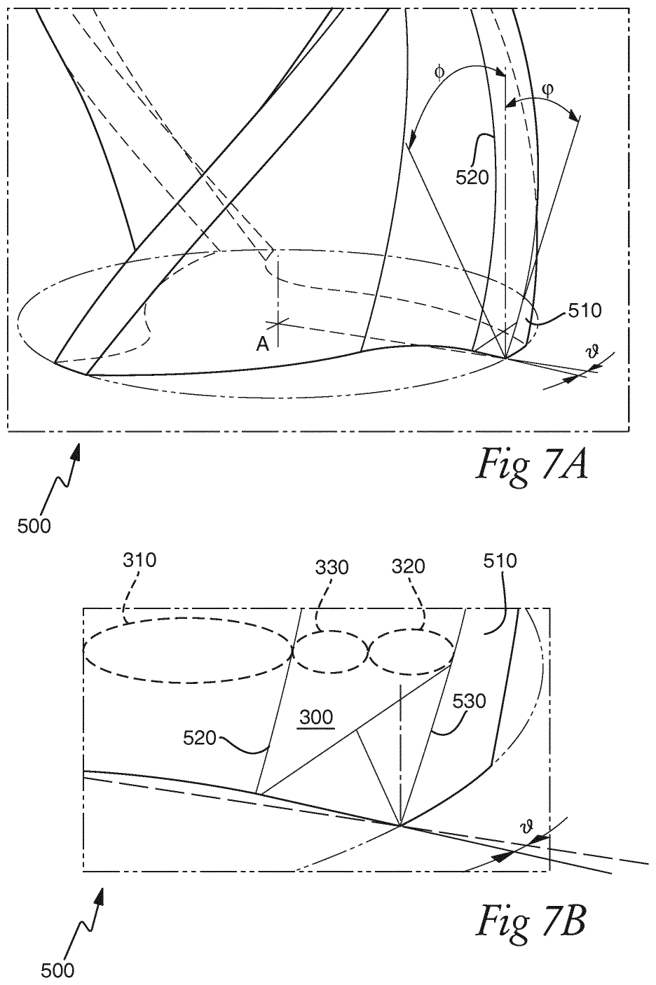

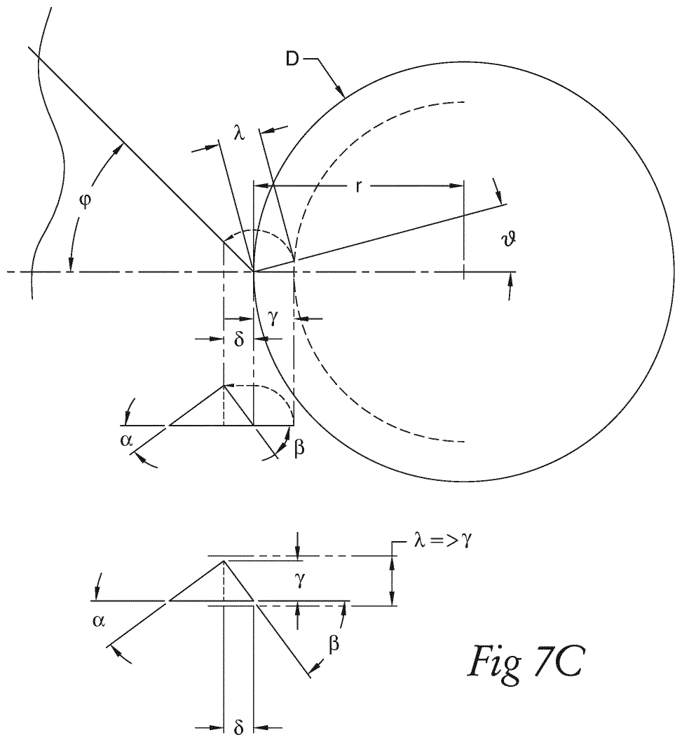

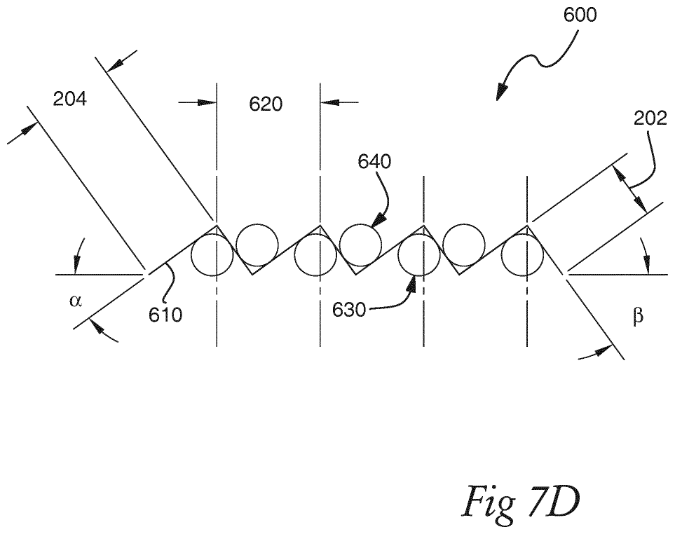

Some of the above features can also be observed and are annotated on FIGS. 7A and 7B, in which the relative locations of the concave portion 310 of the flute surface 160 relative to the rake face surface 300, the locations of first region 320 and second region 330 relative to the rake face surface 300 and to each other, and the location of concave portion 310 relative of the locations of first region 320 and second region 330 are shown (based on at least some portion of the edge 530 in this blank becoming a portion of the radial cutting edge 164 in the final tool). However, it should be noted that at least the radial extent of each of the first region 320 and the second region 330 can vary from that relative proportions depicted in FIG. 7B.

As described above, the extent of the flute surface 162 occupied by the rake face surface 300 can vary. This variation influences the chip forming dynamics when the tool 100 cuts a workpiece.

In alternative embodiments, the rake face surface 300 can have a non-planar geometry. For example, in a cross-section orthogonal to the longitudinal center axis of rotation at an axial position corresponding to the convexly curved crest edge 178 of at least one tooth 170, the rake face surface 300 can have a non-planar surface geometry that separates a concave portion 310 of the flute surface 162 from the radial cutting edge 164. In this case, both the rake face surface 300 and the concave portion 310 are concave, but the amount or degree of concavity for the rake face surface 300 and the concave portion 310 are not equal. In exemplary embodiments, the degree of concavity of the concave portion 310 is greater than the degree of concavity of the concave rake face surface 300 (or, comparing radii defining the concave surfaces, the radius of the concave portion 310 is smaller than the radius of the rake face surface 300).

The clearance surface 166 is illustrated variously in FIGS. 6B to 6E. In these cross-sectional views, the relationship between the clearance surface 166 and the imaginary circle 400 defined by a radially outermost portion of the radial cutting edge 164 at that cross-section is observable. In some embodiments, the clearance surface 166 and the imaginary circle 400 are co-extensive. Alternatively, at least a portion of the clearance surface 166 is radially inward of an imaginary circle 400. Further optional features associated with the clearance surface include having multiple clearance surfaces. For example, a primary, a secondary and/or a tertiary clearance surface can optionally be present. When present, the multiple clearance surfaces can be at different radial distances from the longitudinal center axis of rotation A-A′ or at different clearance angles (the angle between the clearance surface 166 and the tangent to the imaginary circle 400). The same clearance angle can be used by two different clearance surfaces as long as those clearance surfaces are not consecutively positioned, i.e., the primary and tertiary clearance surfaces can be oriented at the same clearance angle. In an example embodiment the clearance angle may have a range of 0 degrees to 20 degrees, alternatively, 1 degree to 10 degrees.

Additionally and as seen in, for example, FIGS. 2A and 4A, the clearance surfaces 166 extend circumferentially in a direction that is perpendicular to the longitudinal center axis of rotation A-A′. Stated another way, in some embodiments an imaginary circumferentially extending line bisects the clearance surface 166 and is oriented perpendicular to a plane containing the longitudinal center axis of rotation A-A′ (see for example, plane 190 in FIG. 4A). In embodiments in which the clearance surfaces 166 extend circumferentially in a direction that is perpendicular to the longitudinal center axis of rotation A-A′, better control of the clearance angle of the tool is provided by eliminating the potential of the clearance surfaces to drag (make contact) with the workpiece material during the cutting operation.

Each radial cutting edge 164 includes a helix shape and a radial rake as further described herein. The radial rake may be a positive rake, a negative rake, or both. It can be zero also. For example, the radial rake may have a range of negative 20 degrees to positive 20 degrees, alternatively, a range of negative 12 degrees to negative 6 degrees, and further alternatively a range of positive 12 degrees to positive 6 degrees. The helix may be a right-hand helix, a left-hand helix, or both (for instance in a compression type tool). The helix angle may have a range of 0 degrees to 60 degrees, alternatively a range of 35 degrees to 50 degrees. Additionally, each radial cutting edge 164 may be configured for either or both of roughing and finishing.

Although illustrated and described above with respect to one tooth of a radial cutting edge 164, the description and features of this one tooth can alternatively apply to a majority of teeth in a radial cutting edge 164 as well as, alternatively, all of the teeth of a radial cutting edge 164. It is expressly contemplated that cutting tools 100 can include the above descriptions and features on one to ten teeth 170 in the tooth pattern 172 of any one or more cutting edges 164, a majority of all teeth 170 in the tooth pattern 172 of any one or more cutting edges 164, or all teeth 170 in the tooth pattern 172 of one or more radial cutting edges 164.

The features disclosed and described herein and shown in the figures can be implemented into rotary cutting tools at various combinations of pitch and diameter. For example, the profile of the radial cutting edge 164 can be considered to comprise multiple cutting faces (corresponding to the teeth in the tooth pattern) that are located along a cutting length of the rotary cutting tool. The distance between these cutting faces (or between crests of the teeth in the tooth pattern of the radial cutting edge) can vary within a pitch range of 1 to 32 teeth per inch (1 to 13 teeth per centimeter). The pitch of any tool also relates to the number of flutes and the determination of coarse pitch, medium pitch or fine pitch depends on both the teeth per inch and on the diameter of the tool. In general, a pitch range of 1 to 10 faces per inch (1 to 4 faces per centimeter) may be referred to as a “coarse pitch;” a pitch range of 11 to 21 faces per inch (4 to 8 faces per centimeter) may be referred to as a “medium pitch;” and a pitch range of 22 to 32 faces per inch (9 to 13 faces per centimeter) may be referred to as a “fine pitch.” The values of pitch range and diameter for the specific implementation of a roughing end mill style rotary cutting tool are shown in Tables 2A (in teeth per inch) and 2B (in SI system units of teeth per cm).

TABLE 2A
Pitch (in teeth per inch) for various diameters (in inches) in
example rotary cutting tools.

| | ROUGHING END MILL STYLE | | | | |
|---|---|---|---|---|---|
| | MULTI FLUTE GENERAL | | 3 FLUTE GENERAL | | 3 FLUTE |
| NOMINAL | PURPOSE | | PURPOSE | | ALUMINUM |
| END MILL | COARSE | FINE | COARSE | FINE | COARSE |
| DIAMETER | (teeth per inch) | (teeth per inch) | (teeth per inch) | (teeth per inch) | (teeth per inch) |
| 3/16″ | 12 to 16 | 26 to 30 | 12 to 16 | 26 to 30 | 12 to 16 |
| ¼″ | 12 to 16 | 26 to 30 | 12 to 16 | 26 to 30 | 12 to 16 |
| 5/16″ | 8 to 12 | 16 to 18 | 12 to 16 | 26 to 30 | 8 to 12 |
| ⅜″ | 8 to 12 | 16 to 18 | 12 to 16 | 26 to 30 | 8 to 12 |
| 7/16″ | 8 to 12 | 16 to 18 | 12 to 16 | 26 to 30 | 8 to 12 |
| ½″ | 8 to 12 | 16 to 18 | 8 to 12 | 16 to 18 | 6 to 10 |
| ⅝″ | 6 to 10 | 12 to 16 | 8 to 12 | 16 to 18 | 4 to 8 |
| ¾″ | 6 to 10 | 12 to 16 | 8 to 12 | 16 to 18 | 4 to 8 |
| ⅞″ | 6 to 10 | 12 to 16 | 6 to 10 | 12 to 16 | 4 to 8 |
| 1.″ | 6 to 10 | 12 to 16 | 6 to 10 | 12 to 16 | 4 to 8 |
| 1-⅛″ | 4 to 8 | 8 to 12 | 6 to 10 | 12 to 16 | 4 to 8 |
| 1-¼″ | 4 to 8 | 8 to 12 | 6 to 10 | 12 to 16 | 3 to 7 |
| 1-½″ | 4 to 8 | 8 to 12 | 4 to 8 | 8 to 12 | 3 to 7 |
| 1-¾″ | 4 to 8 | 8 to 12 | 4 to 8 | 8 to 12 | 3 to 7 |
| 2.″ | 4 to 8 | 8 to 12 | 4 to 8 | 8 to 12 | 3 to 7 |
| 2-½″ | 3 to 7 | 8 to 12 | 4 to 8 | 8 to 12 | 3 to 7 |
| 3.″ | 2 to 6 | 6 to 10 | 3 to 7 | 6 to 10 | 3 to 7 |

TABLE 2B
Pitch (in teeth per centimeter) for various diameters (in millimeter)
in example rotary cutting tools.

| | ROUGHING END MILL STYLE | | | | |
|---|---|---|---|---|---|
| | | | 3 FLUTE GENERAL | | 3 FLUTE |
| NOMINAL | MULTI FLUTE GENERAL PURPOSE | | PURPOSE | | ALUMINUM |
| END MILL | COARSE | FINE | COARSE | FINE | COARSE |
| DIAMETER | (teeth per cm) | (teeth per cm) | (teeth per cm) | (teeth per cm) | (teeth per cm) |
| 4 mm | 5 to 6 | 10 to 12 | 5 to 6 | 10 to 12 | 5 to 6 |
| 6 mm | 5 to 6 | 10 to 12 | 5 to 6 | 10 to 12 | 5 to 6 |
| 8 mm | 3 to 5 | 6 to 7 | 5 to 6 | 10 to 12 | 3 to 5 |
| 10 mm | 3 to 5 | 6 to 7 | 5 to 6 | 10 to 12 | 3 to 5 |
| 11 mm | 3 to 5 | 6 to 7 | 5 to 6 | 10 to 12 | 3 to 5 |
| 12 mm | 3 to 5 | 6 to 7 | 3 to 5 | 6 to 7 | 2 to 4 |
| 16 mm | 2 to 4 | 5 to 6 | 3 to 5 | 6 to 7 | 1 to 3 |
| 20 mm | 2 to 4 | 5 to 6 | 3 to 5 | 6 to 7 | 1 to 3 |
| 22 mm | 2 to 4 | 5 to 6 | 2 to 4 | 5 to 6 | 1 to 3 |
| 25 mm | 2 to 4 | 5 to 6 | 2 to 4 | 5 to 6 | 1 to 3 |
| 28 mm | 1 to 3 | 3 to 5 | 2 to 4 | 5 to 6 | 1 to 3 |
| 32 mm | 1 to 3 | 3 to 5 | 2 to 4 | 5 to 6 | 1 to 3 |
| 36 mm | 1 to 3 | 3 to 5 | 1 to 3 | 3 to 5 | 1 to 3 |
| 45 mm | 1 to 3 | 3 to 5 | 1 to 3 | 3 to 5 | 1 to 3 |
| 50 mm | 1 to 3 | 3 to 5 | 1 to 3 | 3 to 5 | 1 to 3 |
| 63 mm | 1 to 3 | 3 to 5 | 1 to 3 | 3 to 5 | 1 to 3 |
| 76 mm | 1 to 3 | 2 to 4 | 1 to 3 | 2 to 4 | 1 to 3 |

The rotary cutting tool 100 may optionally have internal channels for delivery of coolant (liquid or gaseous) to the cutting area. When present, such internal channels may run internally in a longitudinal direction and helically patched as necessary to extend from the shank portion to an exit opening in the fluted cutting end portion 120, typically in the flute surfaces and/or in the surfaces of the end surface 130.

Additionally, the features disclosed and described herein and shown in the figures can be implemented in both solid body rotary cutting tools, in which the radial cutting edge 164 (and its associated features including one or more of the tooth pattern and the rake face surface) is formed integrally with the tool body, and in rotary cutting tools utilizing removable cutting inserts, in particular indexable cutting inserts, in which the radial cutting edge (and its associated features including one or more of the tooth pattern and the rake face surface) is formed on a removable cutting insert that is mounted in a seating pocket formed in the tool body.

The rotary cutting tool 100 disclosed herein can be manufactured utilizing the following general procedures.

For the solid body rotary cutting tool, a blank of the tool is made by any suitable technique, such as by consolidating hard materials, such as carbide, tungsten carbide or other composite, or by casting with or without machining from an alloy, such as a high-speed steel. The blank has the general elongate form of the tool body and includes helically extending flutes and related radial cutting edges. FIG. 7A is a schematic illustration of an example blank 500 of the disclosed cutting tool showing a portion of the fluted cutting end portion 120 at the forward end of the peripheral surface 140 where it meets the end surface 130. FIG. 7B is a magnified view of a portion of FIG. 7A. In the blank 500 of FIGS. 7A and 7B, the teeth 170 and tooth pattern 172 of the radial cutting edges 164 have not yet been formed. However, the helical web 510 in which the teeth 170 and tooth pattern 172 of the radial cutting edges 164 are to be formed and other features of the flute 160 can be observed, including the rake face surface 300, which in this embodiment is planar in the radial direction and curved in the axial direction, and the flute surface 162. Also visible is the transition 520 between the rake face surface 300 and the flute surface 162. Also annotated in FIGS. 7A and 7B are the radial rake angle (ϑ), the helix angle (φ), and the plane of maximum shear potential (ϕ). The measurement of these angles is also indicated in FIG. 7A.

The blank is subject to machining, for example grinding, to form the teeth 170 and the tooth pattern 172 disclosed herein. Grinding can be by any suitable technique, such as with CBN, aluminum oxide and diamond grinding wheels, and is generally assisted by computer controlled positioning and translating equipment. The machining removes material of the helical web 610 to obtain the teeth having the selected values of first angle (α) and second angle (β) within the ranges disclosed herein. Additionally, grinding achieves the other geometric parameters of the teeth and tooth pattern, including for example the planar or non-planar form of the leading edge 174 and trailing edge 176, the curvature of the crest edge 178 and the valley 184, and the pitch of the teeth in the tooth pattern.

For the removable cutting insert rotary cutting tool, a blank of the tool body is made by any suitable techniques, including for example those discussed above for the solid body rotary cutting tool. The blank has the general elongate form of the tool body and includes helically extending flutes and a helically extending web, similar to that shown in FIG. 7A. Seating pockets for removable indexable cutting inserts are formed in the helically extending web. The seating pockets are correspondingly sized, spaced and oriented to accommodate the intended removable indexable cutting insert at the desired orientation for the various associated features and surfaces, including the radial cutting edge 164 with teeth 170 in a tooth pattern 172, the clearance surface 166, and the rake face surface 300, all of which are formed on the removable indexable cutting insert.

It is also contemplated that a rotary cutting tool could implement a combination of the radial cutting edge 164 (and its associated features including one or more of the tooth pattern and the rake face surface) formed integrally with the tool body and the radial cutting edge 164 (and its associated features including one or more of the tooth pattern and the rake face surface) formed on the removable indexable cutting insert, which is then mounted in a seating pocket on the rotary cutting tool.

In forming the disclosed rotary cutting tool, the relationship between the first angle (α) and second angle (β) in the imaginary triangle 210 can vary with the helix angle (φ), the radial rake angle (ϑ), and the tool radius (r) as shown in the following equations and illustrated in FIG. 7C, which is a schematic diagram illustrating the geometric relationship of various features of the rotary cutting tool and the tooth of the radial cutting edge when the angle between the leading edge side and the trailing edge side is 90 degrees. The length (a) of the trailing edge side of the imaginary triangle 210 is calculated using the following formula:

a=r−({square root over (((sin ϑ)×C)²+(r−((cos ϑ)×C))²)}) (Eq. 1)

where r is the tool radius, ϑ is the radial rake angle, and C is a constant having same unit as the tool radius. The length (b) of the leading edge side of the imaginary triangle 210 is calculated using the following formula:

b=(cos φ)×C (Eq. 2)

where φ is the helix angle. The second angle (β) can be calculated using the following formula (when the angle between the leading edge side and the trailing edge side is 90 degrees, i.e., the angle of the apex vertex 212 is 90 degrees):

$$β = arctan ( \frac{a}{b} ) \qquad ( Eq . 3 )$$

In the upper portion of FIG. 7C, the length of the base of the right triangle formed by the leading edge side of the imaginary triangle is labeled (δ) and the length of the height of the right triangle formed by the leading edge side is labeled (γ). The first angle (α) can be calculated using the following formula:

(α+β+θ)=180 (Eq. 4)

where θ is the angle between the leading edge side and the trailing edge side, i.e., the angle of the apex vertex 212.

As discussed earlier, the sum of the first angle (α) and the second angle (β) is 80 degrees to 100 degrees. Accordingly, the angle between the leading edge side and the trailing edge side, i.e., the angle of the apex vertex 212 (designated by θ in the following equations), can vary from between 80 degrees to 100 degrees. For values of the angle (θ) of the apex vertex 212 different from 90 degrees yet within the interval of 80 degrees to 100 degrees, Equation 1 can be used for calculation of the length of the trailing edge side and Equation 2 can be used for calculation of the length of the leading edge side. The second angle (β) can be calculated using the law of sines using the following formula:

$$β = arcsin ( \frac{b \cdot sin ( θ )}{d} ) \qquad ( Eq . 5 )$$

where:

d=\sqrt{a²+b²−2·a·b·cos(θ)} (Eq. 6)

where a is the length of the leading edge side and b is the length of the trailing edge side. For clarification, din the above equations is the length of the base side 218 of the imaginary triangle 210 and the length d is obtained using the law of cosines.

In the above equations, the units for length dimensions can be metric or English, as long as they are the same throughout the equations. Also, the first angle (α) and the second angle (β) can be expressed in degrees or radians.

The constant C is the same in both the length along the rake face and along the helix to create the compound angle that is the plane of maximum shear potential. The schematic in FIG. 7C labels the length used to determine constant C as λ, and the length λ is equal to or greater than a. In example embodiments, the total height of the roughing form must be within the length of the rake face to provide a true plane in relation to the maximum shear potential. The length λ used to determine constant C is also the minimum rake face length required for the cutting tool to accommodate the roughing form. The length λ used to determine constant C will vary in required height based upon the pitch distance of the tool configuration, for example, a coarse pitch configuration will have a larger form height than a fine pitch configuration. As an example, a coarse pitch may have a form height of 0.040 (1 mm) and a fine pitch may have a form height of 0.020 (0.5 mm); therefore, as examples, the constant C for a coarse pitch will be 0.040 (1 mm) and the constant C for a fine pitch will be 0.020 (0.5 mm).

Other features illustrated in the schematic in FIG. 7C include the tool diameter D.

FIG. 7D is a schematic representation 600 illustrating relationships relevant to the determining a desired roughing form profile. For example, after calculating a desired second angle (β) using the above approach discussed in connection with Eqs. 1-4, one can select a desired pitch distance and then generate the lengths of the sides of the roughing form profile 610. Here, the desired pitch distance 620 can be selected by the tool designer based on number of radial cutting edges (e.g., the flutes) on the tool, the material to be machined, and the feed range. These three parameters can be subsequently modified based on testing to achieve a desired tool performance. The curvature crest radius and valley radius of the roughing form profile 610 are also shown in FIG. 7D (represented by circles 630 and 640, respectively, circumscribed by portions of the roughing form profile 610). The crest radius and valley radius reduce the stress concentration between leading edges and trailing edges and are, generally, of circular configuration, although elliptical configurations can also be used. The values for the crest radius and valley radius are typically larger for harder workpiece materials, such as titanium or nickel-based alloys, and smaller for softer workpiece materials, such as aluminum or bronze.

For clarification, it is noted that the lengths of the leading edge side and the trailing edge side calculated by and used in the equations/formulas above, are only theoretical lengths associated with the imaginary triangle 210. The true lengths (or final lengths) physically present on the cutting tool may be somewhat shortened when the convexly curved crest edge 178 and/or the curved valley 184 are taken into consideration. Also, if the projections of the edges are convex or concave instead of straight, the true lengths are somewhat longer.

The above equations can be used to design and construct a rotary cutting tool with a selected tool radius tool radius (r), helix angle (φ), radial rake angle (ϑ), and determine the first angle (α) and second angle (β). Inversely, if one designs for a specific first angle (α) and specific second angle (β), the above equations can be used to determine the helix angle (φ), radial rake angle (ϑ), and tool radius (r) to implement such a first angle (α) and second angle (β).

In example embodiments, the following information in Table 3 was used in and obtained from the above equations, wherein Example A is a Coarse Pitch and Example B is a Fine Pitch:

TABLE 3

| | | | | | | Length of | Length of | | |
|---|---|---|---|---|---|---|---|---|---|
| | | Radial rake | | | | leading | trailing | Second | First |
| | Helix angle | angle | Tool | Tool | | edge | edge | angle | angle |
| | (φ) | (ϑ) | diameter | radius | Constant | side | side | (β) | (α) |
| Ex. | [deg] | [deg] | [inch] | [inch] | C [inch] | [inch] | [inch] | [deg] | [deg] |
| A | 45 | 15 | 1.0 | 0.5 | 0.040 | 0.0283 | 0.0385 | 53.7117 | 36.2883 |
| B | 45 | 15 | 1.0 | 0.5 | 0.020 | 0.0141 | 0.0193 | 53.7545 | 36.2455 |

In both the solid body form and the removable cutting insert form, the rotary cutting tool disclosed herein can be utilized to remove material from a workpiece by mounting the rotary cutting tool with the above described radial cutting edge (and its associated features including one or more of the tooth pattern and the rake face surface) to a spindle of an apparatus for machining, such as a machine tool or a computer numerical control (CNC) machine, rotating the mounted rotary cutting tool, and removing material from the workpiece by contacting the radial cutting edge to the workpiece. Alternatively, the rotary cutting tool with the above described radial cutting edge (and its associated features including one or more of the tooth pattern and the rake face surface) can be mounted in a stationary position in an apparatus for machining and the workpiece can be positioned, moved, and or rotated and contacted to the radial cutting edge to remove material from the workpiece. The workpiece may be a metal material, which may be ferrous or nonferrous, a metal alloy material, a natural or a synthetic material, or a composite of two or more different materials. The geometries for radial rake angle and helix angle will typically vary based on, at least in part, the properties of the material to be machined, and will result in an attendant variation in the plane of maximum shear potential and resulting in varying values for the angles (α) and (β) related to the tooth geometry.

The features of the teeth and of the tooth pattern on the radial cutting edge as well as the features of the rake face surface described and shown herein contribute to control chip generation in both effective shear and flow direction, and contribute to reduce heat and stresses at a cutting zone. This reduction of heat and stresses at a cutting zone reduces the rate of damage or breakage of the rotary cutting tool 100, and contributes to extend the working life of the rotary cutting tool 100.

To study these beneficial results, a model of a rotary cutting tool having the structural features disclosed herein was run in a simulation of a cutting operation. Details of the cutting tool model and the simulation conditions are shown in Table 4.

TABLE 4

| Tool Parameters | Workpiece Parameters | Process Parameters |
|---|---|---|
| Cutting | Material: 1.7225 | Spindle |
| diameter = 12.7 mm | (DIN 42CrMo4) | speed = 3800 rpm |
| Alfa = 35.43° | Yield strength = 518 MPa | Feed per |
| Beta = 54.47° | Hardness = 200 Bhn | tooth = 0.07 mm |
| Helix angle = 45° | | Radial width of |
| Radial rake angle = 6° | | cut = 4.8 mm |
| | | Coolant = none |

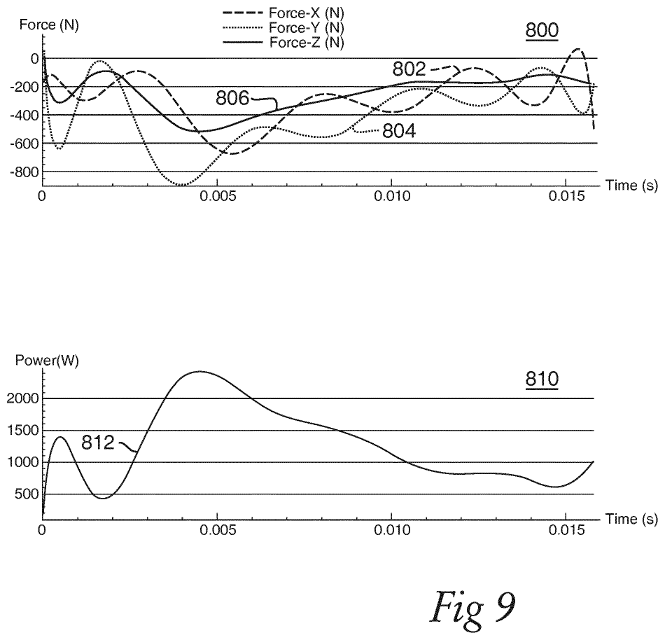

FIG. 9 shows graphs of select characteristics of a rotary cutting tool having the structural features disclosed herein during the above simulation of chip formation flow. The top graph 800 shows force as a function of time in an x-direction 802, a y-direction 804, and a z-direction 806, and illustrates that the force loads during machining are very close together indicating a very stable machining condition. The bottom graph 810 shows power 812 exerted as a function of time of operation of the rotary cutting tool 100.

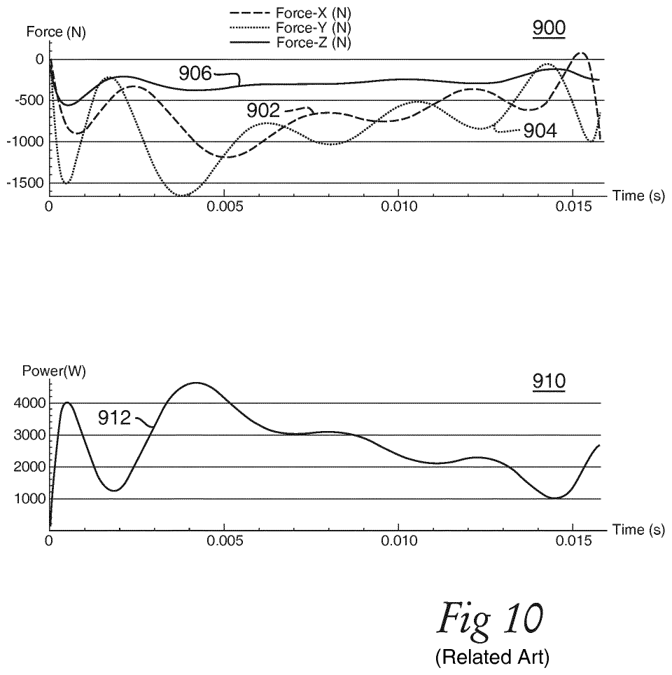

FIG. 10 shows graphs of select characteristics of a related art rotary cutting tool during a simulation of chip formation flow. The tool parameters for the related art rotary cutting tool used in the simulation are provided in Table 5. The cutting conditions and workpiece for the simulation for the related art rotary cutting tool were consistent with those for the simulation for the rotary cutting tool having the structural features disclosed herein.

TABLE 5

| Tool Parameters | | |
|---|---|---|
| (related art used in | Workpiece | |
| simulation) | Parameters | Process Parameters |
| Cutting | Material: 1.7225 | Spindle speed = 3800 rpm |
| diameter = 12.7 mm | (DIN 42CrMo4) | Feed per tooth = 0.07 mm |
| Sinusoidal | Yield | Radial width |
| Radius = 0.75 mm | strength = 518 MPa | of cut = 4.8 mm |
| Helix angle = 30° | Hardness = 200 Bhn | Coolant = none |
| Radial rake | | |
| angle = 10° | | |

In FIG. 10, the top graph 900 shows force as a function of time in an x-direction 902, a y-direction 904, and a z-direction 906. The bottom graph 910 shows power 912 exerted as a function of time of operation of the related art rotary cutting tool.

Comparing the information from the simulation using the model of a rotary cutting tool having the structural features disclosed herein (see FIG. 9) to the information for the model of the related art rotary cutting tool (see FIG. 10), one observes that machining with the model of a rotary cutting tool having the structural features disclosed herein generated reduced cutting forces, most notably in the x-direction and in the y-direction, and exerted reduced power over time, each of which are indicative of a more efficient machining operation with reduced cutting forces, more stability, and smaller chip size and improved chip management.

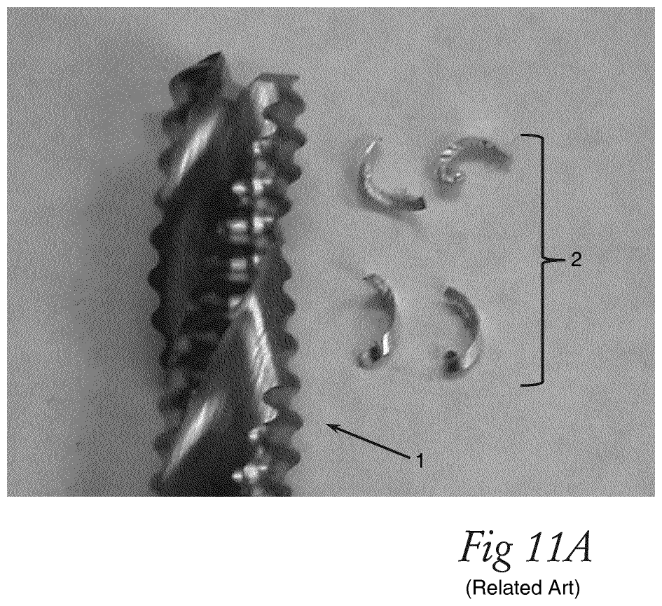

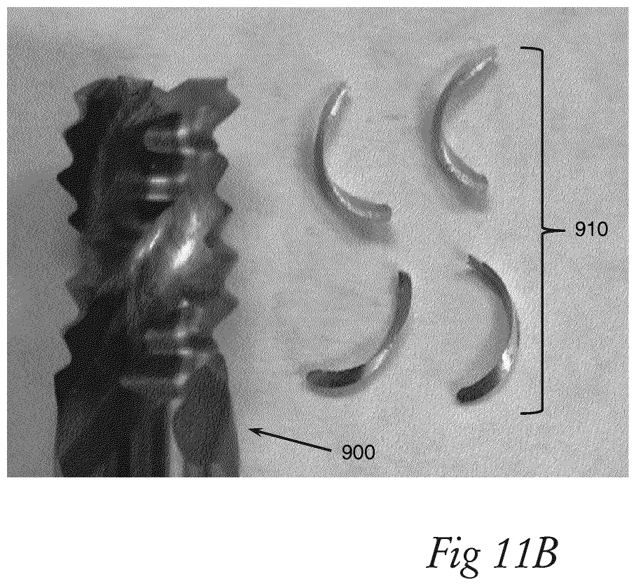

FIG. 11A is a view of a rotary cutting tool 1 and chips 2 in accordance with a related art. FIG. 11B is a view of a rotary cutting tool 900 and chips 910 in accordance with an embodiment of the disclosed rotary cutting tool. The related art rotary cutting tool 1 does not have the tooth configuration as described and illustrated herein for the disclosed rotary cutting tools 100 and 900. This difference in structure between the related art rotary cutting tool 1 in FIG. 11A and the embodiment of the disclosed rotary cutting tool 900 in FIG. 11B results in a difference in cutting behavior, as well as the thermal and physical stresses produced during the cutting process. The existing roughing end mill (rotary cutting tool 1) is shown in FIG. 11A along with the chips 2 that are formed therefrom, which are of a segmented condition and have a tight curl that are indicators of stresses produced on the rotary cutting tool 1 during the chip formation process. An embodiment of the disclosed rotary cutting tool 900 is shown in FIG. 11B along with chips 910 that are formed therefrom, which have a considerably lower degree of segmentation and a very light (e.g., loose) curl that are visual indications of the reduction in stresses during the chip formation process, at least as compared to the tight curl chips 2 in the related art rotary cutting tool 1.

Although the present invention has been described in connection with embodiments thereof, it will be appreciated by those skilled in the art that additions, deletions, modifications, and substitutions not specifically described may be made without departure from the spirit and scope of the invention as defined in the appended claims.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A rotary cutting tool, comprising:
a tool body comprising a longitudinal center axis of rotation, the tool body being elongated and rotatable along the longitudinal center axis of rotation;
a fluted cutting end portion and a shank portion that is axially opposite the fluted cutting end portion, the fluted cutting end portion comprising a periphery surface and an end surface;
at least one flute including a flute surface, the flute surface projecting radially inward into the tool body and extending along a first portion of the periphery surface in an axial direction of the tool body;
a clearance surface extending circumferentially along a second portion of the periphery surface, and forming part of a wave pattern in an axially extending direction; and
a radial cutting edge formed at an intersection of the flute surface and the clearance surface,
wherein the radial cutting edge has a radial cutting edge geometry comprising a plurality of teeth arranged in a tooth pattern extending axially along the radial cutting edge,
wherein each tooth of the tooth pattern has a profile that includes a leading edge, a trailing edge, and a convexly curved crest edge joining the leading edge to the trailing edge, the largest radial distance of the radial cutting edge located in the convexly curved crest edge,
wherein, in the tooth pattern, a leading edge of an axially rearward tooth is joined to a trailing edge of an axially forward tooth by a curved valley, the valley defining the smallest radial distance of the radial cutting edge,
wherein a projection of at least one tooth of the tooth pattern onto an imaginary plane at a midpoint of the leading edge of the at least one tooth and containing the longitudinal center axis comprises a projection of the leading edge, a projection of the tailing edge and a projection of the crest of the at least one tooth, said projection of the at least one tooth forms an imaginary triangle, the imaginary triangle having:
(i) an apex vertex located at an intersection of an imaginary extension of the projection of the leading edge of the at least one tooth and an imaginary extension of the projection of the trailing edge of the at least one tooth,
(ii) a leading vertex located at an intersection of the imaginary extension of the projection of the leading edge of the at least one tooth and an imaginary extension of a projection of the trailing edge of the axially forward tooth onto the imaginary plane, and
(iii) a trailing vertex located at an intersection of the imaginary extension of the projection of the trailing edge of the at least one tooth and an imaginary extension of a projection of the leading edge of the axially rearward tooth onto the imaginary plane,
wherein the imaginary triangle has a leading edge side between the apex vertex and the leading vertex, a trailing edge side between the apex vertex and the trailing vertex, and a base side between the leading vertex and the trailing vertex,
wherein the trailing edge side is oriented at a first angle (α) relative to the base side and the leading edge side is oriented at a second angle (β) relative to the base side, and
wherein the second angle (β) is greater than the first angle (α).

2. The rotary cutting tool according to claim 1, wherein the radial cutting edge is helically curved.

3. The rotary cutting tool according to claim 2, wherein a helical curvature of the helically curved radial cutting edge continually changes with axial position relative to the longitudinal center axis.

4. The rotary cutting tool according to claim 1, wherein, in a projected profile of the at least one tooth, at least one of the projection of the leading edge and the projection of the trailing edge is non-planar.

5. The rotary cutting tool according to claim 1, wherein, in a profile of an imaginary surface created by at least one tooth in the tooth pattern when the tool is rotated about the longitudinal center axis of rotation, at least one of the leading edge and the trailing edge is non-planar.

6. The rotary cutting tool according to claim 1, wherein the first angle (α) is 25 degrees to 44 degrees.

7. The rotary cutting tool according to claim 1, wherein the second angle (β) is 46 degrees to 65 degrees.

8. The rotary cutting tool according to claim 1, wherein the first angle (α) is 25 degrees to 44 degrees and the second angle (β) is 46 degrees to 65 degrees.

9. The rotary cutting tool according to claim 8, wherein a sum of the first angle (α) and the second angle (β) is 80 degrees to 100 degrees or more preferably wherein the sum is between 85 and 95 degrees and most preferably wherein the sum is between 88 and 92 degrees.

10. The rotary cutting tool according to claim 1, wherein the flute surface includes a rake face surface adjacent both (a) at least a portion of the leading edge and (b) at least a portion of the trailing edge, and wherein at least a portion of the rake face surface is planar in a radial direction and curved in an axial direction.

11. The rotary cutting tool according to claim 1, wherein the flute surface includes a rake face surface,
wherein the rake face surface is adjacent the radial cutting edge,
wherein the rake face surface includes a first region located radially outward of an imaginary baseline formed by connecting an apex of the axially forward valley and an apex of the axially rearward valley and is adjacent to at least a portion of the convexly curved crest edge, and
wherein the first region is planar in a radial direction and curved in an axial direction.

12. The rotary cutting tool according to claim 11, wherein the rake face surface includes a second region located radially inward of the imaginary baseline, and wherein the second region is planar in the radial direction and curved in the axial direction.

13. The rotary cutting tool according to claim 1, wherein a portion of the flute surface adjacent the radial cutting edge defines a rake face surface,
wherein, in a radial cross-section at an axial position corresponding to the convexly curved crest edge of at least one tooth, the rake face surface has a planar surface geometry, and
wherein the planar surface geometry separates a concave portion of the flute surface from the radial cutting edge.

14. The rotary cutting tool according to claim 1, wherein a portion of the flute surface adjacent the radial cutting edge defines a rake face surface,
wherein, in a radial cross-section at an axial position corresponding to the convexly curved crest edge of at least one tooth, the rake face surface has a non-planar surface geometry, and
wherein the non-planar surface geometry separates a concave portion of the flute surface from the radial cutting edge.

15. The rotary cutting tool according to claim 14, wherein the non-planar surface geometry is concave.

16. The rotary cutting tool according to claim 1, wherein the convexly curved crest edge is tangentially connected to at least one of the trailing edge and the leading edge.

17. The rotary cutting tool according to claim 1, wherein, in each radial cross-section, the clearance surface is coextensive with an imaginary circle defined by a radially outermost portion of the radial cutting edge.

18. The rotary cutting tool according to claim 1, wherein, in a radial cross-section, at least a portion of the clearance surface is radially inward of an imaginary circle defined by a radially outermost portion of the radial cutting edge.

19. The rotary cutting tool according to claim 1, wherein the tooth pattern extends axially over at least a majority portion of an axial length of the fluted cutting end portion.

20. The rotary cutting tool according to claim 1, wherein the rotary cutting tool comprises a plurality of flutes.

21. The rotary cutting tool according to claim 20, wherein the plurality of teeth arranged in the tooth pattern of the radial cutting edge of a first flute are geometrically the same as the teeth arranged in the tooth pattern of the radial cutting edge of a second flute.

22. The rotary cutting tool according to claim 20, wherein the tooth pattern of the radial cutting edge of the first flute is axially staggered from the tooth pattern of the radial cutting edge of the second flute.

23. The rotary cutting tool according to claim 20, wherein the tooth pattern of the radial cutting edge of the first flute is radially staggered from the tooth pattern of the radial cutting edge of the second flute.

24. The rotary cutting tool according to claim 1, wherein the tool body has a cylindrical shape, a conical shape, or a contoured shape.

25. The rotary cutting tool according to claim 1, wherein the radial cutting edge is formed integrally with the tool body.

26. The rotary cutting tool according to claim 1, wherein the radial cutting edge is formed on a removable cutting insert that is mounted in a seating pocket formed in the tool body.

27. A method to remove material from a workpiece, the method comprising:
rotating the rotary cutting tool according to claim 1, the rotary cutting tool mounted to a spindle of machine tool; and
removing material from the workpiece by contacting the radial cutting edge of the rotary cutting tool to the workpiece.
